(19) United States
(12) Patent Application Publication
(10) Pub. No.: US 2006/0085470 A1
(43) Pub. Date: Apr. 20, 2006

(54) Database record templates

(76) Inventors: Matthias Schmitt, Heidelberg (DE); Stefan Dieter Schreck, Oftersheim (DE); Carsten Koehler, Muehlhausen (DE); Axel Werner, Heidelberg (DE)

Correspondence Address: FISH & RICHARDSON, P.C., PO BOX 1022, MINNEAPOLIS, MN, 55440-1022, US

(21) Appl. No.: 10/966,042

(22) Filed: Oct. 15, 2004

(51) Int. Cl. G06F 17/00; G06F 7/00

(52) U.S. Cl. 707/102

(57) ABSTRACT

A method of creating an electronic database record includes receiving input from a user in a computer system to create an electronic database record; determining, upon receiving the input, a template to be used in populating the electronic database record from among several templates; and creating the electronic database record by associating the set of attribute values included in the determined template with the electronic database record. Another embodiment provides a method of processing a database record that comprises, upon accessing the electronic database record, retrieving the set of attribute values included in the template associated with the database record.

### TECHNICAL FIELD

This description relates to creating and maintaining database records using templates.

### BACKGROUND

Electronic databases are powerful tools for organizing information. A company may use an electronic database to maintain records about its customers or business partners. The records may enable the company to send a bill to a customer or business partner or to deliver product to either.

A typical company's electronic database may consume a large amount of storage space in a computer system. Often, much of the data in an electronic database is common to multiple records. It may be inefficient for a user to enter common data. The user may spend time manually entering common data, and repeatedly entering common data may increase the likelihood of data entry errors. Common data may also increase the amount of storage space that an electronic database requires. Moreover, changes to common data may require modifications to multiple database records. Existing techniques for entering and initiating data may not be flexible.

### SUMMARY

The invention relates to database record templates.

In a first general aspect, a method of creating an electronic database record comprises receiving input to create an electronic database record, the input being received from a user in a computer system. The method comprises determining, upon receiving the input, a template for the electronic database record, the template being determined from among several templates. The electronic database record is created. A set of attribute values included in the template is associated with the electronic database record.

In some embodiments, determining the template involves using a decision tree. Determining the template may involve using a rule selected using a read method, the rule identifying the template from which data is to be retrieved.

Associating the set of attribute values with the electronic database record may involve copying the attribute values. Copied attribute values may be editable and may be unaffected by subsequent attribute-value changes in the template.

Associating the set of attribute values with the electronic database record may involve referencing the attribute values from the template. Referenced attribute values may be non-editable and may be affected by subsequent attribute-value changes in the template. A list can be dynamically generated to identify any database record that references the attribute values in a template.

In some embodiments, the template includes one or more subtemplates. The template may obtain some or all of its attribute values from the one or more subtemplates.

In a second general aspect, a method of creating and using a template in an electronic database comprises querying a user of a computer system for a first set of attributes and a first set of attribute values to associate with each other. Input is received from the user in response to the query. A first data structure is instantiated in the electronic database, the first data structure comprising the first set of attributes and the first set of attribute values input by the user. The method comprises subsequently associating the first data structure with a rule to be applied when accessing an electronic database record.

Advantages of the systems and techniques described herein may include any or all of the following. Reducing the time needed to enter data into an electronic database. Reducing the frequency of errors in entering data into an electronic database. Reducing the amount of storage space required by an electronic database. Minimizing the number of changes to the electronic database when modifying data in one or more records. Increasing flexibility in managing electronic databases. Providing templates that are flexible and can comprise or contain any kind of reusable object.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of an exemplary database system including templates;

FIG. 1B is a block diagram with further details of the exemplary database system shown in FIG. 1A;

FIGS. 2A-C are examples of graphical user interfaces (GUIs) that can be generated by the system shown in FIG. 1A or 1B;

FIG. 3 is a flow chart of a method of creating and populating the new database record using a template;

FIG. 4 is a flow chart of a method of creating and using a template in an electronic database;

FIG. 5 is a block diagram of an exemplary computer system.

Like reference symbols in the various drawings indicate like elements.

### DETAILED DESCRIPTION

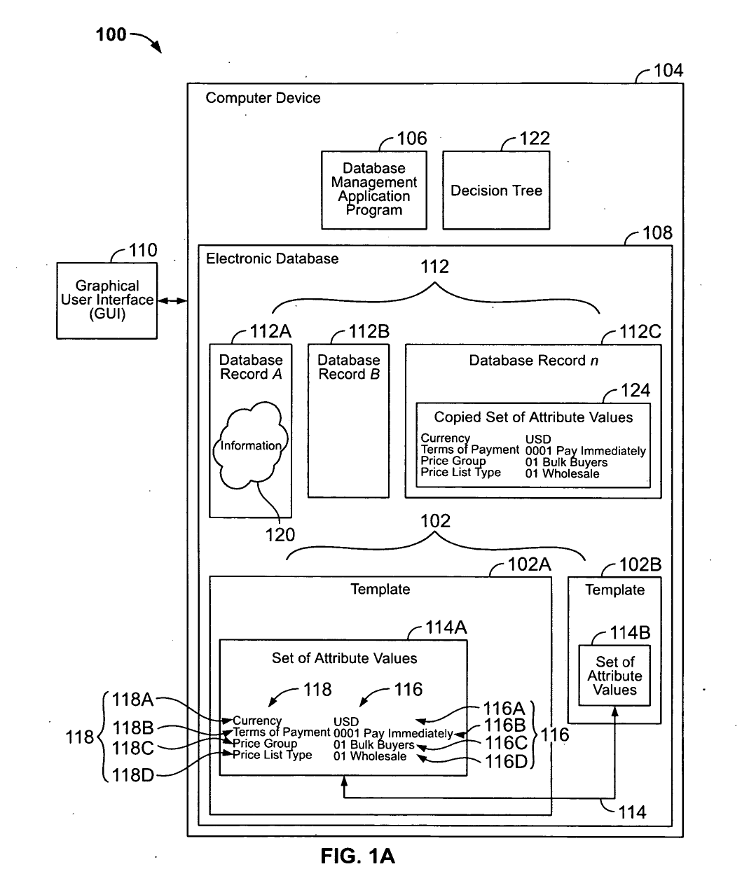

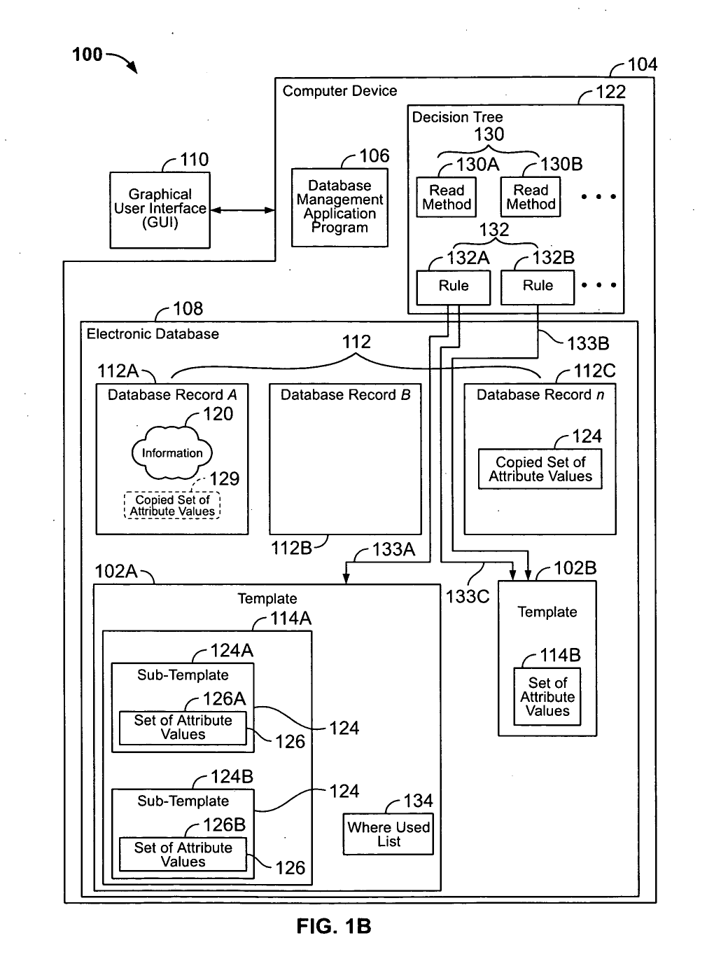

FIG. 1A is a block diagram of an exemplary electronic database system (database system) 100. The system includes one or more templates 102 as will be described below. With the database system, a user can store, retrieve, process and organize information. The database system 100 includes a computer device 104 capable of executing application programs, including a database management application program 106. The computer device 104 uses the database management application program 106 to manage information stored in an electronic database 108. Information in the electronic database 108 may be organized in one or more database records 112. The database system 100 also includes a graphical user interface (GUI) 110 through which a user can communicate with the computer device 104. In response to input from the user through the GUI 110, the computer device can create and maintain database records 112. In one embodiment, the electronic database 108 may be part of a company's Customer Relationship Management (CRM) system, and the individual database records 112 may contain records for specific customers or business partners of the company.

The electronic database also includes one or more templates 102, which facilitate entry and storage of information in the database system 100. Each template instance 102 includes a set of attribute values 114, and the set of attribute values 114A comprises one or more attribute values 116 and one or more corresponding attributes 118 of data in the electronic database 108. For example, templates can be instances of a common template type, and may include reusable objects. In the CRM system embodiment mentioned above, a database record containing a customer record may include billing information that comprises the attributes and attribute values shown in Table 1 below.

TABLE 1

| Attribute | Attribute Value |
|---|---|
| Currency | USD United States Dollar |
| Terms of Payment | 0001 Pay immediately |
| Price Group (Cust) | 01 Bulk buyers |
| Price List Type | 01 Wholesale |

In this example, as shown in Table 1 and in FIG. 1A, the attribute “Currency” has the attribute value “USD United States Dollar”; the attribute “Terms of Payment” has attribute value “0001 Pay immediately”; and so on.

Instances of the templates 102 may be associated with database records 112. When the computer device 104 processes a database record 112 with which a template 102 is associated, the computer device 104 may retrieve the set of attribute values 114. For example, referring again to a CRM system, if a template 102A including the set of attribute values 114A shown in FIG. 1A is associated with a customer record 112A, the computer device 104, upon processing the customer record 112A, may retrieve the units of currency (U.S. dollars) and the price list type (wholesale) from the template 102A.

The templates 102 may be preconfigured with sets of attribute values 114 during the initial configuration of the electronic database 108, or the templates 102 may be created by the user as part of entering and manipulating data during a typical use of the electronic database 108. In one embodiment, the electronic database 108 includes several preconfigured templates 102. Here, the template 102A includes attribute values 116 that are associated with respective attributes 118. The exemplary attributes and associated values in Table 1 have been identified as attribute values 116A-D and attribute values 118A-D, respectively, in FIG. 1A.

To create a new database record 112A using a preconfigured template 102A, in one embodiment, a user inputs certain information in the GUI 110. Upon receipt of the user input, the computer device 104 may create a shell for the new database record 112A. Next, based on the input information, the computer device 104 may determine a template 102A from among the preconfigured templates 102 to use in populating the new database record 112A.

In one embodiment, the user selects the template. For example, the computer device 104 may determine a specific template 102A in response to the user selecting the template 102A from among other templates 102 displayed to the user in the GUI 110. There may be different templates that specify currency in U.S. dollars, euros or yen, respectively. If the database record represents a customer in the United States, the user may select a template that specifies currency in U.S. dollars.

In another embodiment, the computer device 104 determines the template 102A from among the several templates 102 based on information 120 that relates to the database record 112A. For example, the user can enter the information 120 to initiate the creation of the database record 112A. The information 120 may identify some context in which the user created the database record 112A. For example, in the process of creating a database record to store billing information for a customer, the user may have already entered the customer's address, including a country component. The country component may be stored in the information 120 as context for other billing information. If there are different templates that specify currency in U.S. dollars, euros or yen, the computer device 104 may determine that billing information should be derived from the template 102A that specifies the currency that corresponds to the country identified by the country component in the information 120. To determine the template 102A from among the several templates, the computer device may execute a decision tree 122, wherein the decision tree determines from which template to retrieve a set of attribute values. The decision tree 122 will be further explained with reference to FIG. 1B.

Once the computer device 104 has determined which template 102A to use in populating the database record 112A, it may populate the database record 112A by associating the set of attribute values 114A with the database record 112A. For example, the association may be made by copying or referencing the set of attribute values.

When the set of attribute values 114A is referenced in the database record 112A, the attribute values 114A will be displayed to a user that accesses the database record. For example, the attribute values 114A may be displayed in the GUI 110. However, the displayed attribute values 114A will not be editable in the database record 112A. Moreover, a change of the attribute values in the template 102A will be reflected in the database record.

Association by copying may include the computer device 104 storing a copy of the set of attribute values 114A in one of the database records 112. One example of an association by copying is illustrated in database record 112C. As shown, a copied set of attribute values 124 may be stored in the database record 112C. Initially, the copied set of attribute values 124 may be identical to the set of attribute values 114A from which the copied set of attribute values 124 was made. According to one embodiment, subsequent changes to the copied set of attribute values 124 may not affect the set of attribute values 114A; similarly, changes to the set of attribute values 114A may not affect the copied set of attribute values 124.

FIG. 1B is a block diagram showing additional details of the exemplary database environment 100. The template 102A may include one or more sub-templates 124. Each sub-template 124 may include a set of attribute values 126 that are provided to the template 102. Here, the set of attribute values 114A comprises the sets of attribute values 126A and 126B. In one embodiment, the sub-template may be the smallest unit for grouping the attribute values 116 shown in FIG. 1A.

The sub-templates 124 may be preconfigured with sets of attribute values 126 as part of the initial configuration of the electronic database 108. Alternatively, the sub-templates 124 may be created and configured by the user with certain attributes 118 and attribute values 116 as part of the entry and manipulation of data during a typical use of the electronic database 108. In one embodiment, the electronic database 108 includes several preconfigured sub-templates 124.

FIG. 1B also shows one example of an association by reference of the set of attribute values 114A with the database record 112A. The decision tree 122 may include a sequential list of read methods 130, wherein each of the read methods can be executed to identify one of several rules 132. If one read method successfully identifies a rule that retrieves data for a particular database record, no further processing of the read methods takes place for this record. The rule identifies one of the templates 102 from which to retrieve a set of attribute values. Accordingly, an outcome of applying the rule is to identify a relationship for retrieving the attribute values. For example, applying the rule 132A may result in the template 102A being identified, as schematically illustrated by an arrow 133A from the rule 132A to the template 102A. Another rule may identify a different template. For example, a rule 132B may identify the template 102B, as schematically illustrated by an arrow 133B. A rule may be time dependent. For example, the rule 132A may include a time stamp attribute that affects what template is identified by the rule. That is, applying the rule may involve using a parameter for the time stamp attribute. Depending on the parameter, the rule 132A can identify the template 102A (arrow 133A) or the template 102B, as schematically illustrated by an arrow 133C. For example, a customer's current billing address may be included in the set of attribute values 114A, and a future billing address may be included in the set of attribute values 114B. Using the decision tree 122 in the electronic database system 100 may reduce the number of copies of the set of attribute values that need to be stored in the electronic database 108.

Changes to the set of attribute values are reflected in each database record that references the set of attribute values. For example, if the set of attribute values 114B is changed when the attribute values are referenced in a database record, the computer device 104 may subsequently process the database record 112A, apply the rule 132A, which may follow the arrow 133C, and retrieve the changed set of attribute values. Similarly, if the computer device 104 processes the database record 112B and applies the rule 132B that follows arrow 133B, the computer device 104 may retrieve the changed set of attribute values.

In one scenario, both database records 112A and 112B reference the same set of attribute values 114A. If a user of the electronic database 108 wishes to modify the set of attribute values 114A that is associated by reference with the first database record 112A, but does not wish to affect the same set of attribute values 114A associated by reference with the second database record 112B, additional steps may be required. One way to modify the set of attribute values 114A associated by reference with the first database record 112A without affecting the set of attribute values 114A associated by reference with the second database record 112B is to perform the following steps:

A) The computer device 104 may receive user input from the GUI 110 to modify the set of attribute values 114A associated by reference with the first database record 112A;

B) The computer device 104 may copy the set of attribute values 114A into a copied set of attribute values 129. This may include instantiating a new template instance and a new rule that identifies the new template instance. Applying the new rule will identify the copied set of attribute values 129 and provide them to the database record that caused the new rule to be applied.

C) The computer device 104 may receive additional user input through the GUI 110 specifying how the copied set of attribute values 129 is to be modified;

D) The computer device 104 may modify the copied set of attribute values 129 in response to the additional user input.

In a scenario wherein a user wishes to change the referenced set of attribute values 114A, it may be advantageous to provide the user with a list 134 of any database records that reference the set of attribute values 114A. The following is one way of providing the list 134 (hereafter, the list 134 is referred to as the “Where Used List 134”). The Where Used List can be determined dynamically when a user wishes to modify a set of attribute values in a template. Determining the Where Used List 134 dynamically may include identifying the rules that identify that template, and based on the identified rules, determining which database records apply that rule.

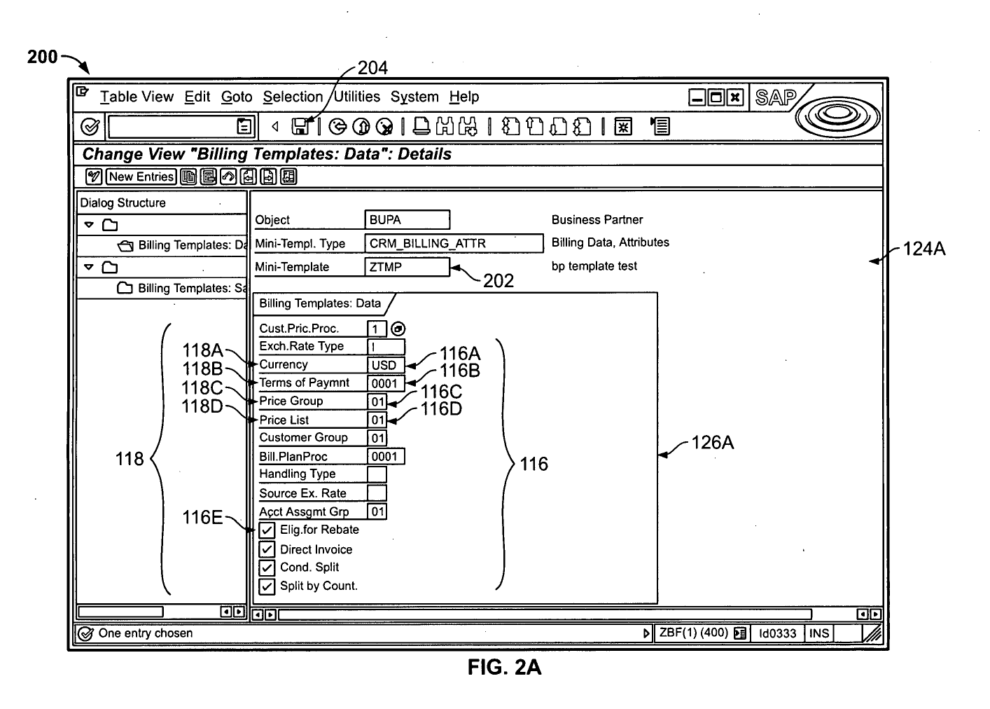

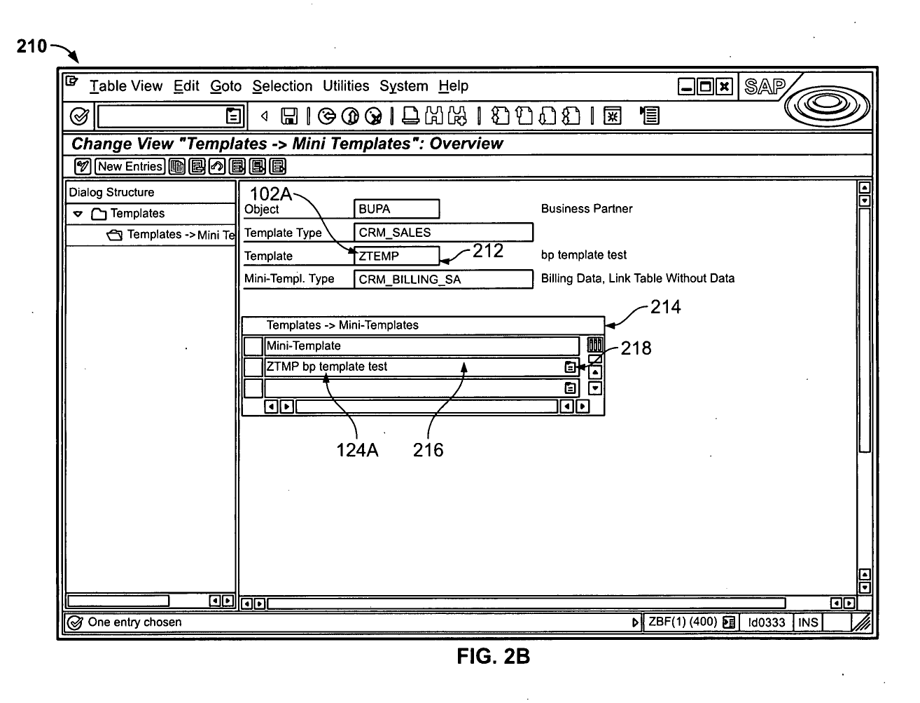

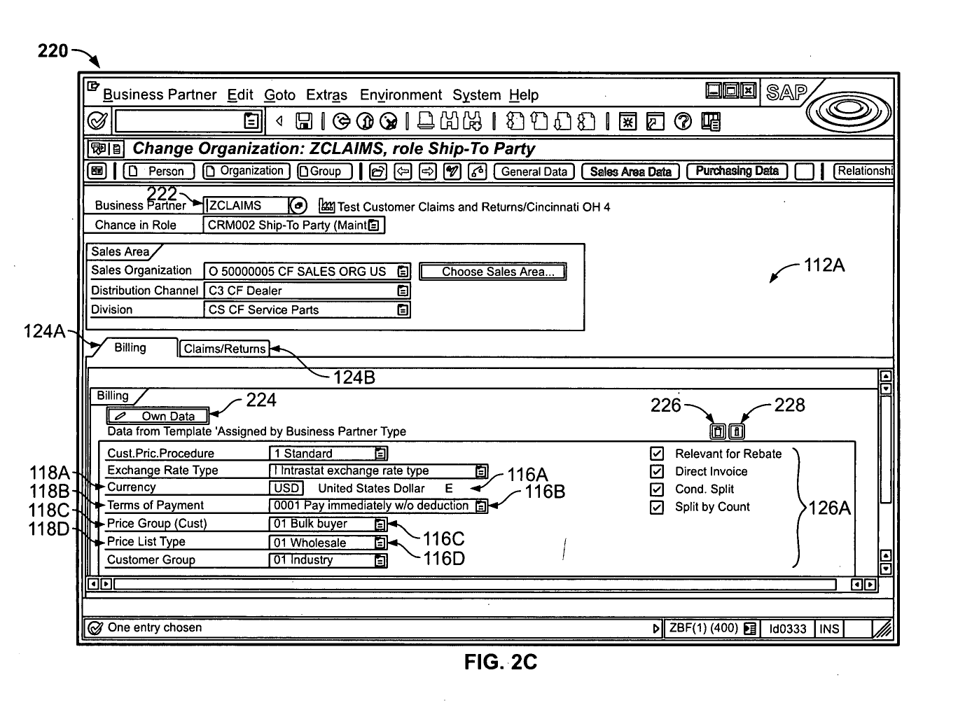

FIG. 2A is one example of a GUI 200 that may be used for managing a set of attribute values 126A in a sub-template 124A. The user may specify the sub-template 124A in a sub-template specification field 202 (here, “ZTMP”). If the specified sub-template has already been preconfigured, as it has in this example, the computer device 104 may display the preconfigured attributes 118 and attribute values 116 in the GUI 200. Alternatively, the attributes 118 may be configurable by the user through a user interface similar to the user interface 200. In the example shown in FIG. 2A, the user may modify a particular attribute value 116A by selecting it, modifying it and saving the changes. To select the attribute value 116A in the user interface 200, the user may manipulate a pointing device, a keyboard, or other data input device. Similarly, to modify the attribute value 116A, the user may manipulate a pointing device, keyboard or other data input device. Attribute values 116 may include character data 116A, numerical data 116B, check boxes 116E and other types of data.

Saving changes to the set of attribute values 126A in the sub-template 124A may include the user entering a command with a keyboard, using a pointing device to select an icon 204, or otherwise entering input that directs the computer device 104 to store the sub-template 124A in its current state. The above example illustrates a user interface 200 for maintaining a set of attribute values 126A. A similar interface may also be used to maintain a set of attribute values 114B in a template 102B.

FIG. 2B shows one example of a user interface 210 that may be used to include the sub-template 124A in the template 102A. As shown in FIG. 2B, the user may enter the name for the template 102A (here, “ZTEMP”) in a template specification field 212. Upon receiving the input, the computer device 104 may display a list 214 of sub-templates that are already included in the template 102A. The list 214 may provide the user with an entry field 216 in which to input one or more additional sub-templates 124A (here, “ZTMP bp template test”) to include in the template 102A. The entry field 216 may include a selection aid 218 that the user may select to choose the additional sub-template from among several sub-templates. The selection aid 218 may be in the form of a drop-down list, a dialog box or other method of assisting a user in selecting a sub-template to include in the template 102A.

FIG. 2C shows an example of a user interface 220 that may be used to create and populate a new database record 112A using the existing template 102A. The interface may contain a database record field 222 in which the user may enter the name of the new database record 112A (“ZCLAIMS” in this example). In one embodiment, the new database record 112A belongs to a type or class of database records that has already been defined in the electronic database 108. For instance, in the following example, the new database record 112A is of a type of database record defined for a company's general contact records, or business partner records. The type or class of the new database record 112A may be stored in the information 120 included in the new database record 112A.

Upon input of the new database record 112A by the user in the database record field 222, the computer device 104 may determine which template 102A from among the templates 102 to associate with the new database record 112A. For example, the computer device 104 may determine the template 102A based on user selection of the template 112A, based on execution of the decision tree 122, or by some other method. Assume that the computer device 104 determines the template 102A based on execution of the decision tree 122, wherein the execution of the decision tree 122 uses information 120 related to the database record 112A. In this example, the computer device 104 may execute the decision tree 122 and associate by reference template 102A with the new database record 112A. In processing the database record 112A, the computer device 104 will retrieve the set of attribute values 114A included in the template 102A and display them in the user interface. If the first sub-template 124A and the second sub-template 124B are included in the template 102A, then the computer device 104 may display the set of attribute values 126A included with the first sub-template 124A separately from the set of attribute values 126B included in the second sub-template 124B. For example, as shown in FIG. 2C, the computer device 104 may display the set of attribute values 126A retrieved from the sub-template 124A as a “tab” in an arrangement of several “windows” in the user interface, wherein each window has its own tab.

The user interface 220 may also include an input control 224 that the user may select to modify the set of attribute values 126A. The input control 224 may be an “Own Data” selection box that the user may select with a pointing device, or the input control 224 may be some other method for the computer device 104 to receive user input. In this example, if the user selects the input control 224, and the set of attribute values 126A is currently associated with the database record 112A by reference, then the set of attribute values may instead be copied to the database record 112A, as illustrated in FIG. 1B. Thereafter, the attribute values are editable and the user can modify the attribute values. If, on the other hand, the set of attribute values 126A is associated with the database record 112A by having already been copied, the input control 224 may be inactive, and the user may directly modify the set of attribute values 126A.

If data has been copied to a database record, the GUI 220 lets the user undo the copying and revert to default values for the data. For example, the GUI 220 may include an input control 226 that, when selected, causes the copied data to be deleted. Moreover, the deleted data can be replaced by referencing other attribute values from a template that is associated with a rule that can be applied when accessing the database record. Accordingly, the control 226 provides that the copied and perhaps modified data is replaced with data from a template.

The GUI 220 lets the user determine the source of the referenced set of attribute values. For example, the user may select an input control 228 to identify a template from which the currently displayed data has been obtained. If obtaining the data involves applying a rule, or if the data was obtained from a sub-template, the GUI 220 may identify the rule or the sub-template.

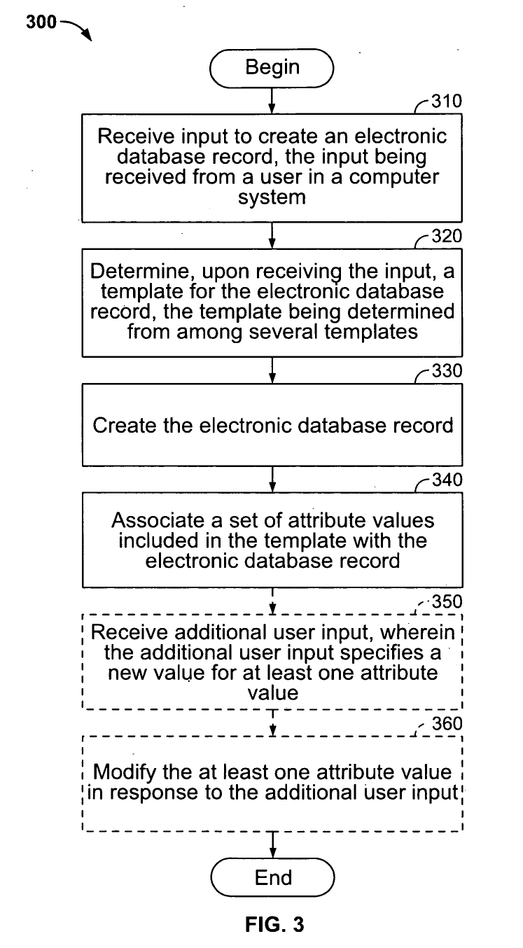

FIG. 3 is a flow chart of a method 300 of creating and populating a database record, according to one embodiment. The method 300 may be performed in the computer device 104. For example, a computer program product can include instructions that cause a processor to perform the steps of method 300. The following steps are included in method 300:

Receiving, in step 310, input to create an electronic database record, the input being received from a user in a computer system. For example, in the database system 100, the computer device 104 can receive input from a user through the GUI 110 to create a database record 112A in the electronic database 108.

Determining, in step 320, upon receiving the input, a template for the electronic database record, the template being determined from among several templates. For example, the computer device 104 can determine a template 102A for the database record 112A from among several templates 102. The computer device 104 may determine the template 102A based on the user selecting the template 102A in the computer device 108 after reviewing a list of the templates 102 displayed in the computer device 108. The computer device 104 may determine the template by executing a decision tree 122, wherein the decision tree may include rules 132.

Creating, in step 330, the electronic database record. For example, the computer device 104 can create the database record 112A. In one embodiment, this may include creating a shell for the database record 112A and storing information 120 in the shell.

Associating, in step 340, a set of attribute values included in the template with the electronic database record. For example, the computer device 104 can associate the set of attribute values 114A with the database record 112A. The association may be by reference or by copying, to name two examples. The association may be by copying the set of attribute values 114A to a copied set of attribute values 129 in the database record 112A.

The method may further include, in optional step 350, receiving additional user input, wherein the additional user input specifies a new value for at least one attribute value. For example, if the set of attribute values 114A containing the at least one attribute value is associated with the database record 112A by reference, the computer device 104 may copy the set of attribute values 114A to a copied set of attribute values 129 in the database record 112A. If the set of attribute values 114A has already been associated with the database record 112A by copying the copied set of attribute values 129 to the database record 112A, the computer device 104 may omit taking any additional steps.

The method may further include, in optional step 360, modifying the at least one attribute value in response to the additional user input. In one embodiment, the set of attribute values 114A associated with the database record 112A is included in the database record 112A as a copied set of attribute values 129, following optional step 350. According to one embodiment, the computer device 104 may modify the at least one attribute value in the copied set of attribute values 129.

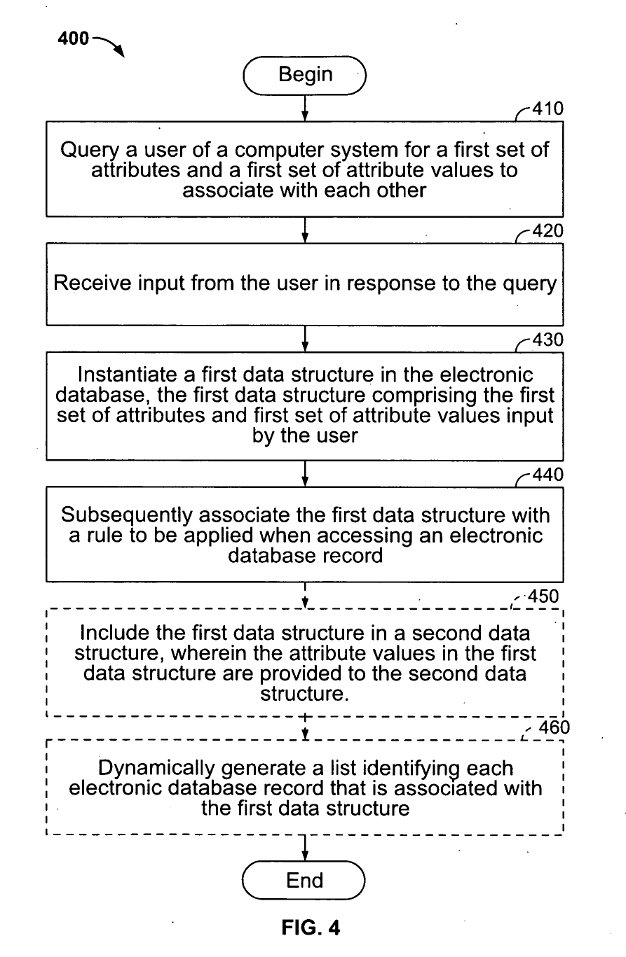

FIG. 4 is a flow chart of a method 400 of creating and using a template in an electronic database, according to one embodiment. The method 400 may be performed in the computer device 104. For example, a computer program product can include instructions that cause a processor to perform the steps of method 400. The following steps are included in method 400:

Querying a user of a computer system, in step 410, for a first set of attributes and a first set of attribute values to associate with each other. For example, the computer device 104 can query a user through the GUI 110 to input attribute values 116 for the attribute values 118.

Receiving input, in step 420, from the user in response to the query. For example, a user, in response to the computer device 104 displaying a query in the GUI 110, can enter the attribute values 116 to be associated with the attributes 118.

Instantiating a first data structure in the electronic database, in step 430, where the first data structure comprises the first set of attributes and first set of attribute values input by the user. For example, referring to FIG. 1A, the computer device 104 can instantiate template 102A and include within the template 102A the set of attribute values 114A which includes the attributes 118 and attribute values 116 input by the user.

Subsequently associating, in step 440, the first data structure with a rule to be applied when accessing an electronic database record. For example, referring to FIG. 1A, the computer device 104 can associate the set of attribute values 114A with the database record 112A. For example, associating the attribute values with the database record may involve copying or referencing the attribute values.

The method may further include, in optional step 450, including the first data structure within a second data structure, wherein the attribute values in the first data structure are provided to the second data structure. For example, referring to FIG. 1B, the first data structure may correspond to the sub-template 124A and the second data structure may correspond to the template 102A. Accordingly, the attribute values in the sub-template 124A may be provided to the template 102A.

The method may further include, in optional step 460, dynamically generating a list identifying each electronic database record that is associated with the first data structure. For example, referring to FIG. 1B, the computer device 104 may generate a Where Used List 134.

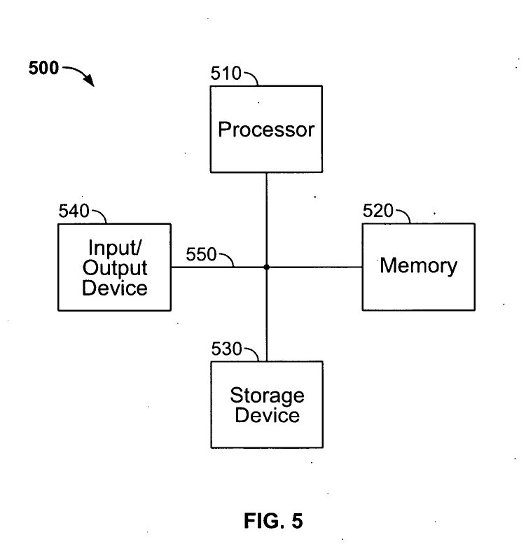

FIG. 5 is a block diagram of a computer system 500 that can be used in the operations described above, according to one embodiment. The computer system 500 includes a processor 510, a memory 520, a storage device 530 and an input/output device 540. Each of the components 510, 520, 530 and 540 are interconnected using a system bus 550. For example, the computer device 104 may include the computer system 500.

The processor 510 is capable of processing instructions for execution within the computer system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the computer system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the computer system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the computer system 500. In one embodiment, the input/output device 540 includes a keyboard and/or pointing device. In one embodiment, the input/output device 540 includes a display unit for displaying GUIs as discussed above with reference to FIGS. 2A-C.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of creating an electronic database record, the method comprising:
receiving input to create an electronic database record, the input being received from a user in a computer system;
determining, upon receiving the input, a template for the electronic database record, the template being determined from among several templates;
creating the electronic database record; and
associating a set of attribute values included in the template with the electronic database record.

2. The method of claim 1, wherein associating the set of attribute values with the electronic database record comprises:
copying the set of attribute values to the electronic database record.

3. The method of claim 2, further comprising:
receiving additional user input, wherein the additional user input specifies a new value for at least one copied attribute value; and
modifying the at least one copied attribute value in response to the additional user input.

4. The method of claim 1, wherein associating the set of attribute values with the electronic database record comprises applying a rule that identifies the template.

5. The method of claim 4, wherein the rule uses information related to the electronic database record in identifying the template, the information having been input by the user for creating the electronic database record.

6. The method of claim 1, wherein a changed attribute value in any one of the several templates is available to be retrieved for each electronic database record with which the one of the several templates is associated.

7. A computer program product tangibly embodied in an information carrier, the computer program product including instructions that, when executed, cause a processor to perform operations comprising:
receiving input to create an electronic database record, the input being received from a user in a computer system;
determining, upon receiving the input, a template for the electronic database record, the template being determined from among several templates;
creating the electronic database record; and
associating a set of attribute values included in the template with the electronic database record.

8. The computer program product of claim 7, wherein the template is determined based on information associated with the electronic database record.

9. The computer program product of claim 7, wherein the set of attribute values has been copied to the electronic database record and wherein the operations further comprise:
receiving additional user input to replace the copied set of attribute values;
deleting the copied set of attribute values; and
providing a new set of attribute values to the electronic database record, the new set of attribute values being referenced from the template.

10. The computer program product of claim 7, wherein the set of attribute values has been referenced from the template and wherein the operations further comprise:
receiving additional user input indicating that the user wants to identify a source of the set of attribute values; and
identifying the template to the user.

11. The computer program product of claim 7, wherein, to associate the set of attribute values with the electronic database record, the set of attribute values is copied to the electronic database record.

12. The computer program product of claim 11, wherein the operations further comprise:
subsequent to the set of attribute values being copied to the electronic database record, receiving additional user input to modify the set of attribute values included in the electronic database record; and
modifying at least one attribute value in the set of attribute values in the electronic database record in response to the additional user input.

13. The computer program product of claim 7, wherein, to associate the set of attribute values with the electronic database record, a rule is applied that identifies the template.

14. The computer program product of claim 13, wherein the operations further comprise:
receiving additional user input to modify the set of attribute values identified by the rule;
copying to the electronic database record the set of attribute values identified by the rule; and
modifying at least one attribute value in the set of attribute values in the electronic database record in response to the additional user input.

15. The computer program product of claim 13, wherein the rule is time-dependent.

16. A method of creating and using a template in an electronic database, the method comprising:
querying a user of a computer system for a first set of attributes and a first set of attribute values to associate with each other;
receiving input from the user in response to the query;
instantiating a first data structure in the electronic database, the first data structure comprising the first set of attributes and the first set of attribute values input by the user; and
subsequently associating the first data structure with a rule to be applied when accessing an electronic database record.

17. The method of claim 16, wherein the first data structure is included in a second data structure, wherein the attribute values in the first data structure are provided to the second data structure.

18. The method of claim 16, further comprising dynamically generating a list identifying each electronic database record that is associated with the first data structure.

19. The method of claim 16 further comprising associating the first data structure with an additional electronic database record.

20. A computer program product tangibly embodied in an information carrier, the computer program product including instructions that, when executed, perform opeartions comprising:
querying a user for a first set of attributes and a first set of attribute values to associate with each other;
receiving input from the user in response to the query;
instantiating a first data structure in the electronic database, the first data structure comprising the first set of attributes and the first set of attribute values input by the user; and
subsequently associating the first data structure with a rule to be applied when accessing an electronic database record.
